(19) United States
(12) Patent Application Publication
(10) Pub. No.: US 2015/0293297 A1
(43) Pub. Date: Oct. 15, 2015

(54) METHOD OF MAKING A LIGHT GUIDE PLATE

(71) Applicant: Wah Hong Industrial Corp., Kaohsiung (TW)

(72) Inventors: Tai-Hsiung CHEN, Tainan City (TW); Jui-Hung WANG, Tainan City (TW)

(73) Assignee: WAH HONG INDUSTRIAL CORP., Kaohsiung (TW)

(21) Appl. No.: 14/252,097

(22) Filed: Apr. 14, 2014

(51) Int. Cl. F21V 8/00; G02B 1/04

(52) U.S. Cl. CPC G02B 6/0065; G02B 6/0043; G02B 1/045

(57) ABSTRACT

A method of making a light guide plate includes: preparing a transparent substrate with a first planar surface and a perforated plate with a second planar surface and perforations; covering the transparent substrate with the perforated plate, such that the perforations expose dot-forming regions of the first planer surface and that the first and second planar surfaces are in intimate contact with each other; applying an ink onto the perforated plate; scraping across the perforated plate to form ink dots on the dot-forming regions, respectively; and removing the perforated plate from the transparent substrate.

### BACKGROUND OF THE INVENTION

1. Field of the invention

This invention relates to a method of making a light guide plate, more particularly to a method of making a light guide plate using a perforated plate.

2. Description of the related art

A display normally includes a screen and a backlight module configured to project light on the screen. The backlight module includes a light guide plate for transmission of light to an assembly of optical members.

In order to enhance light extraction efficiency, a conventional light guide plate normally is formed with a plurality of light-extraction dots thereon. The light-extraction dots can reduce total internal reflection of light in the light guide plate.

The light-extraction dots may be formed on the light guide plate using screen printing techniques or molding techniques. The screen printing techniques involve the use of a woven screen during printing of an ink material on the light guide plate, and are more suitable for making a large size light guide plate compared to the molding techniques. However, the woven screen tends to cause formation of undesired wrinkles of the ink material on the light guide plate.

### SUMMARY OF THE INVENTION

Therefore, an object of the present invention is to provide a method of making a light guide plate that can overcome the aforesaid drawback associated with the prior art.

According to the present invention, there is provided a method of making a light guide plate that comprises: preparing a transparent substrate and a perforated plate, the transparent substrate having a first planar surface, the perforated plate having a working surface, a second planar surface that is opposite to the working surface, and a plurality of perforations that extend through the working surface and the second planar surface; covering the transparent substrate with the perforated plate, such that the perforations expose dot-forming regions of the first planer surface of the transparent substrate and that the first and second planar surfaces are parallel to and are in intimate contact with each other; applying an ink, which contains a light scattering material, onto the working surface of the perforated plate; scraping across the working surface to push the ink into the perforations so as to form a plurality of ink dots on the dot-forming regions of the first planar surface, respectively; and removing the perforated plate from the transparent substrate.

### BRIEF DESCRIPTION OF THE DRAWINGS

In drawings which illustrate an embodiment of the invention,

FIGS. 1(A) to 1(C) are schematic views of the preferred embodiment of a method of making a light guide plate according to the present invention.

### DETAILED DESCRIPTION OF THE PREFERRED EMBODIMENT

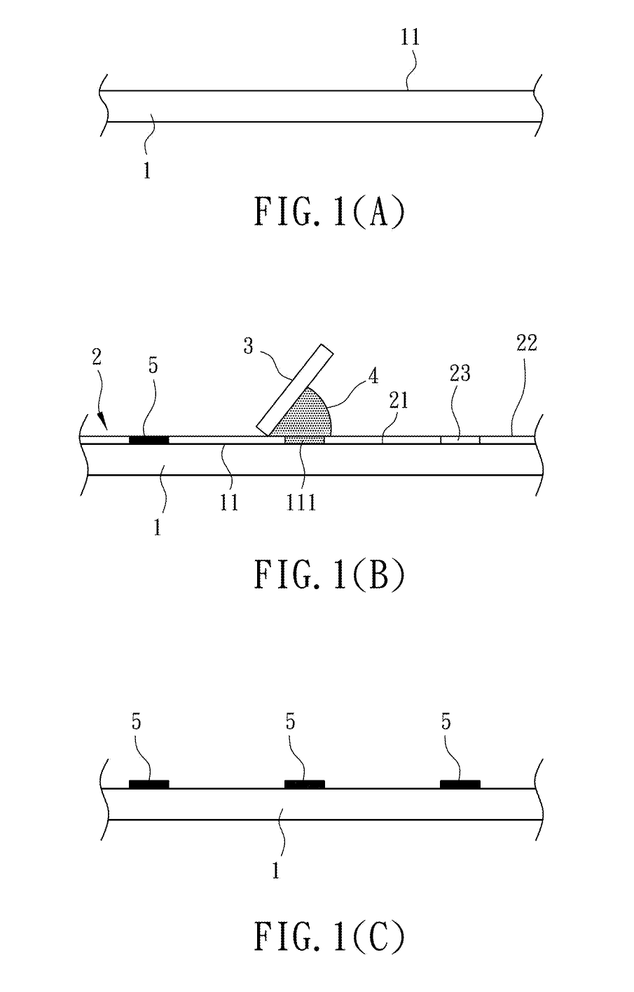

FIGS. 1(A) to 1(C) illustrate the preferred embodiment of a method of making a light guide plate according to the present invention. The method includes the steps of: preparing a transparent substrate 1 and a perforated plate 2, the transparent substrate 1 having a first planar surface 11, the perforated plate 2 having a working surface 22, a second planar surface 21 that is opposite to the working surface 22, and a plurality of perforations 23 that extend through the working surface 22 and the second planar surface 21; covering the transparent substrate 1 with the perforated plate 2, such that the perforations 23 expose dot-forming regions 111 of the first planer surface 11 of the transparent substrate 1 and that the first and second planar surfaces 11, 21 are parallel to and are in intimate contact with each other; applying an ink 4, which contains a light scattering material, onto the working surface 22 of the perforated plate 2; scraping across the working surface 22 using a scraper 3 to push the ink 4 into the perforations 23 so as to form a plurality of ink dots 5 on the dot-forming regions 111 of the first planar surface 11, respectively; drying the ink dots 5; and removing the perforated plate 2 from the transparent substrate 1.

Preferably, the transparent substrate 1 is made from a material selected from the group consisting of polymethylmethacrylate (PMMA), polycarbonate (PC), a transparent copolymer composed of methyl methacrylate and styrene monomer (MS), and polystyrene (PS), and is formed using extrusion molding techniques. The transparent substrate 1 preferably has a thickness of greater than or equal to 0.1 mm and smaller than 4 mm, and more preferably greater than or equal to 0.3 mm and smaller than 0.5 mm. The thickness of the transparent substrate 1 can be better controlled using the extrusion molding technique compared to injection molding technique.

In the preferred embodiment, the transparent substrate 1 is made from PMMA, and the thickness of the transparent substrate is 0.3 mm.

Preferably, the perforated plate 2 is made from metal.

The light scattering material is selected from the group consisting of TiO₂, SiO₂, and the combination thereof. In the preferred embodiment, the ink 4 is a thermosetting ink, and the light scattering material is TiO₂.

Preferably, each of the ink dots 5 has a diameter greater 0.01 mm and smaller than 0.08 mm.

The ink dots 5 are dried by baking. Preferably, the ink dots 5 are baked for 50 minutes to 70 minutes under a temperature ranging from 50° C. to 70° C. In the preferred embodiment, the ink dots 5 are baked for 60 minutes under 60°.

With the use of the perforated plate 2 in the method of the present invention, the second planar surface 21 of the perforated plate 2 can intimately contact the first planar surface 11 of the transparent substrate 1 in such a manner that the ink 4 is prevented from overflowing from the dot-forming regions 111 into regions around the dot-forming regions 111, thereby eliminating the aforesaid drawback associated with the prior art.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A method of making a light guide plate, the method comprising:
preparing a transparent substrate and a perforated plate, the transparent substrate having a first planar surface, the perforated plate having a working surface, a second planar surface that is opposite to the working surface, and a plurality of perforations that extend through the working surface and the second planar surface;
covering the transparent substrate with the perforated plate, such that the perforations expose dot-forming regions of the first planer surface of the transparent substrate and that the first and second planar surfaces are parallel to and are in intimate contact with each other;
applying an ink, which contains a light scattering material, onto the working surface of the perforated plate;
scraping across the working surface to push the ink into the perforations so as to form a plurality of ink dots on the dot-forming regions of the first planar surface, respectively; and
removing the perforated plate from the transparent substrate.

2. The method of claim 1, further comprising drying the ink dots before removing the perforated plate.

3. The method of claim 2, wherein the ink dots are dried by baking.

4. The method of claim 1, wherein the perforated plate is made of metal.

5. The method of claim 1, wherein the transparent substrate is made from a material selected from the group consisting of polymethylmethacrylate (PMMA), polycarbonate (PC), a transparent copolymer composed of methyl methacrylate and styrene monomer (MS), and polystyrene, the transparent substrate having a thickness greater than or equal to 0.1 mm and smaller than 4 mm.

6. The method of claim 5, wherein the thickness of the transparent substrate is greater than or equal to 0.3 mm and smaller than 0.5 mm.

7. The method of claim 1, wherein each of the ink dots has a diameter greater than 0.01 mm and smaller than 0.08 mm.
